(19) United States
(12) Patent Application Publication
(10) Pub. No.: US 2004/0205465 A1
(43) Pub. Date: Oct. 14, 2004

(54) Method of electronically producing documents in a legal proceeding

(75) Inventors: Richard A. Baker JR., West Newbury, MA (US); Edward Jarmolowicz, Webster, MA (US)

Correspondence Address: SQUARE D COMPANY, INTELLECTUAL PROPERTY DEPARTMENT, 1415 SOUTH ROSELLE ROAD, PALATINE, IL, 60067, US

(73) Assignee: Schneider Automation Inc., North Andover, MA (US)

(21) Appl. No.: 10/063,426

(22) Filed: Apr. 23, 2002

(51) Int. Cl. G06F 17/24; G06F 17/21

(52) U.S. Cl. 715/500

(57) ABSTRACT

A method of producing documents in a legal proceeding that comprises the steps of converting the documents to a common file type and then electronically placing bates stamps on each file. The method of placing the bates stamps on the file comprises the placement of bates stamps on each page of each file, incrementing the bates stamp number for each page across the multiple documents. In addition, a computer program for electronically placing bates stamps on each page of a document wherein the bates stamps are incremented through each successive pages and each successive document.

### BACKGROUND OF INVENTION

In a typical litigation in the United States, each party is required to produce relevant documentation to the opposing party. In a commercial civil suit, this may amount to several hundred pages of documentation that is easily managed with paper. However, when the case involves intellectual property, anti-trust or complex litigation, the document production may involve tens of thousands or even a million pages of documentation.

The traditional way to handle this type of document production was to copy each paper document that was found and print out each electronic document. These copies were then stored in rooms full of file cabinets. Typically, each party kept a single master set of files, and each attorney copied the individual pages that were needed.

Often, the master copies would be corrupted due to misplaced documents or lost documents. The copying costs could range upwards towards $100,000, even at a price of several pennies per page.

And it was physically impossible to bring more than a select few documents to court or to a deposition, thus hampering the attorney should the case take an unexpected turn.

### SUMMARY OF INVENTION

The present invention provides a methodology for greatly reducing the logistical problems of dealing with a large number of documents in a litigation by allowing a party to manage document production using electronic media instead of paper.

### BRIEF DESCRIPTION OF DRAWINGS

The foregoing discussion will be understood more readily from the following detailed description of the invention when taken in conjunction with the accompanying drwings, in which:

FIG. 1 is a diagram of the steps required to collect the documentation from the various sources and to create a master archive of the document production.

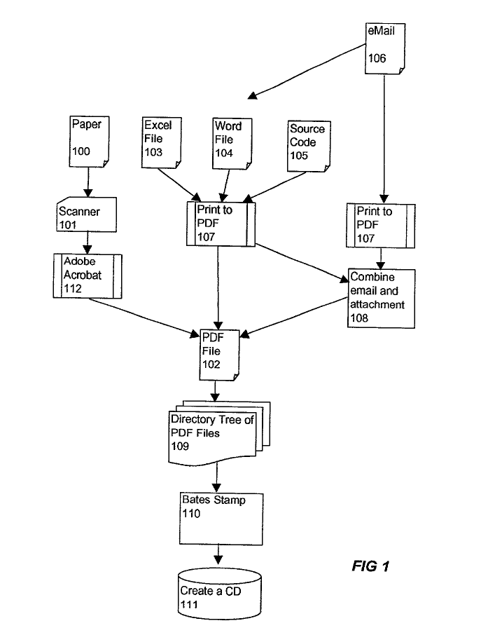

FIG. 2 is a flow chart of the steps needed to place Bates Stamps on each file in the archive

FIG. 3 is the flow chart of the steps to perform the Bates stamping on a specific file.

### DETAILED DESCRIPTION

While this invention is susceptible of embodiments in many different forms, there is shown in the drawings and will herein be described in detail a preferred embodiment of the present invention with the understanding that the present disclosure is to be considered as an exemplification of the principles of the invention and is not intended to limit the broad aspect of the present invention to the embodiment illustrated.

The first step in the document production process is the identification of the documents that have any connection with the litigation. In today's offices, these documents are typically in for form of email 106 or electronic documents, although there still are also paper documents 100. The electronic documents are usually in a number of different forms that are convenient to the application that uses the documents. For instance, spreadsheets 103 are in a form for the spreadsheet application, the text files 104 are in a format for the word processing application.

The first major step in this process is to convert all of these files into a common format 102. The form as chosen for the preferred embodiement is the Portable Document Format (PDF) as defined by Adobe Systems Incorporated. This method requires the use of a version of Adobe Acrobat 112 that allows the user to create PDF file.

We will first address paper documents 100. In order to convert paper into PDF files, we utilize a scanner 101 to scan the documents into a computer readable format. Scanners 101 with auto-feed and a capability to import directly into Adobe Acrobat 112 are particularly useful in rapidly converting paper files into PDF files 102.

For spreadsheet 103, word processing 104, or ASCII 105 files, the conversion into a common format is done by entering into the application native to the file and printing the file to Adobe Acrobat PDF Writer 107. This will create a file in PDF format containing the image of the original file.

Email requires an additional step in some cases. In the simplest case, the email 106 is printed to the PDF Writer 107. However, when the email 106 has an attachment, then the attachment must be processed by its native applications (spreadsheet 103, word processor 104, etc) and printed from that application into PDF format 102. Once the email and the attachment are in PDF format, then the two PDF files need to be combined 108 using Adobe Acrobat 112. This assures the nexus between the email and the attachment.

The above process continues for each relevant document.

In order to preserve the location of the various files, it is preferable to copy each directory tree containing the documents to a separate disk drive, and then convert the files at that location. Each native application file is then removed from the copy directory, so that there is a directory tree 109 the emulates the original directory, with the only difference being that each file is in PDF format instead of the native application file format.

Once this directory tree 109 is created, the attorney reviews each file documents that belong on the privilege log. These files are separated from the directory tree 109.

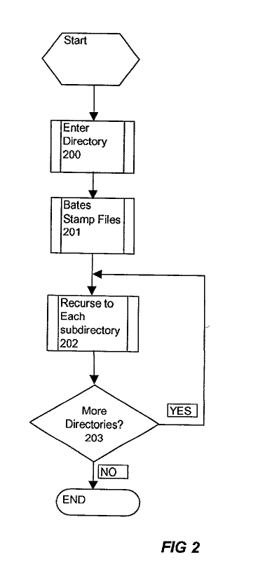

The directory tree 109 is now processed by a program to place bates stamps on each file as seen in FIG. 2. While there are many possible ways to traverse a directory tree, including manual traversal, automatic complete traversal, or an interface such as NT Explorer where the user selects which files to bates stamp.

FIG. 2 shows an automated traversal of the directory tree. The directory is entered 200, and each PDF files is bates stamped 201. The bates stamping is done in this embodiement with a program that uses the StampPDF Batch utility from Appligent, Inc. that is added into Adobe Acrobat.

Once each file is stamped in this directory, the traversal routine recurses into each subdirectory 202 to process the underlying directory tree.

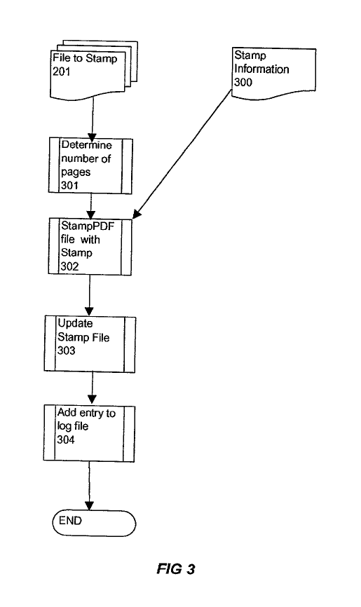

FIG. 3 shows how each file 201 is bates stamped. Before the stamping process, a Stamp file is created using StampPDF batch from Appligent, Inc. This stamp file 300 specifies where the stamp is placed, what font, size, text, and color are used. A stamp color of 50% black was found to be best for stamping both black and white backgrounds, and a location at the top of each file was found to avoid overwriting most documents.

In the stamping process, the program first determines the number of pages in the PDF document 301. This may be done with the PDFPgCnt from Appligent, Inc.

Next, the program StampPDF is called to use the stamp file 300 on the PDF file 201. This will place a bates stamp on each page in the PDF file 201.

The stamp file 300 must be updated to increment the starting bates number. This is done by adding the page count to first bates number in the file.

Then an entry is made at the end of a log file 304 that keeps track of each file that is bates stamped. This log file contains the directory name, the file name, the initial bates number, the ending bates number, and the number of pages.

This entire method creates a directory tree that can be burned onto a CD-ROM 111 for delivery to other attorneys. A single CD may hold 25-30,000 bates stamped pages of document production, and a small stack of CDs can contain all documents in a moderately large case.

While the specific embodiments have been illustrated and described, numerous modifications come to mind without significantly departing from the spirit of the invention, and the scope of protection is only limited by the scope of the accompanying claims.

1. A method for producing documents in a legal proceeding, the method comprising:
converting a set of files to a common electronic file type in a directory tree; and
electronically stamping each file with a bates stamp.

2. The method of claim [1] further including the step of preserving the directory tree on a CD ROM.

3. The method of placing a bates stamp on an electronic document, the method comprising: using a stamping mechanism to place a bates stamp on each page of a file; incrementing the bates stamp for each page of said file; and preserving the next bates stamp number for use by a subsequent file.

4. The method of claim [3] further comprising of the logging of information on the bates stamping in a file.

5. The method of claim [3] wherein the stamping, incrementing, and preserving are performed on multiple files.

6. The method of claim [5] wherein the multiple files are contained in a directory tree.

7. A computer program for electronically placing bates stamps on one or more documents, comprising: software instructions to place a bates stamp on each page of each document; instructions to increment the bates stamp for each page, wherein the incrementing bates numbers are continued through each successive document.

8. The computer program in claim [7] further including instructions to create a log file of each document that is bates stamped.

9. The computer program in claim [7] further including instructions to place the bates stamps on a directory tree of documents.
